(19) United States
(12) Patent Application Publication
(10) Pub. No.: US 2006/0007680 A1
(43) Pub. Date: Jan. 12, 2006

(54) Illumination device for an office product, method of illuminating an office product, and display device for an office product

(75) Inventor: J. Robert Gluck, Lawrence, NY (US)

Correspondence Address: GREENBLUM & BERNSTEIN, P.L.C., 1950 ROLAND CLARKE PLACE, RESTON, VA, 20191, US

(73) Assignee: ROBERT GORDON INDUSTRIES, LTD., Lynbrook, NY (US)

(21) Appl. No.: 10/885,070

(22) Filed: Jul. 7, 2004

(51) Int. Cl. F21V 33/00

(52) U.S. Cl. 362/253

(57) ABSTRACT

A device that illuminates an office product that includes a sensor that senses user interaction with the office product. The office product includes a portion of the office product that is structured and arranged to include at least one of text or an image, and a light that illuminates the portion in response to the sensor sensing the user interaction with the office product. The instant abstract is neither intended to define the invention disclosed in this specification nor intended to limit the scope of the invention in any way.

### BACKGROUND OF THE INVENTION

1. Field of the Invention

The present invention relates to an office product, an illumination device for an office product, and a method of illuminating an office product in order for the office product to be more useful as a promotional device, novelty item, and/or as a gift. The present invention further relates to an office product, a display device for an office product, and a method of displaying text or an image on an office product in order for the office product to be more useful as a promotional device, novelty item, and/or as a gift.

2. Discussion of Background Information

It is known to have an office product that operates with the normal functionality of an office product. For example, it is known to have a stapler that includes a stapler handle, a staple cartridge, and a stapler base. One end of each of these three components are generally attached together through a pin to form a pivot point. The other end of these three parts are more or less separated from one another. When a user presses at least the stapler handle, the stapler handle will move with respect to the staple cartridge and stapler base and the staple cartridge will extend a staple that will extend through sheets of paper. The staple will then contact a striking plate that is generally mounted to the stapler base. The striking plate will bend the legs of the staple in order to fix the staple in the sheets and thus hold the sheets together. When the user releases the stapler handle, a spring that is mounted within the stapler will urge the stapler handle, staple cartridge, and staple base into a standby mode.

The majority of office products, such as a stapler, have only the basic office product functionality such as stapling. In this regard, most improvements to office products are limited to improvements in the office product function. The present invention overcomes the single functional nature of office products to include aspects directed to making the office product more suitable as a promotional product, novelty item, and/or as a gift.

One example of an office product with additional functionality is U.S. Pat. No. 6,471,108 to SHI which discloses An Audio and Video Effect Stapler. This stapler includes a light that is mounted on the stapler that will illuminate when the stapler is used. This type of stapler has very limited ability to promote a commercial product or promote a commercial company, for example, by illuminating a portion with an image or text or displaying text on a display such as set forth in the present invention described herein.

### SUMMARY OF THE INVENTION

The present invention is directed to an office product that includes a sensor that can determine when a user is interacting with the office product. In response to the interaction with the office product, the office product will illuminate at least a portion of the office product or will display an image or text on a display on the office product.

One aspect of the present invention includes a device that illuminates an office product. The office product can include a sensor that senses user interaction with the office product, a portion of the office product that is structured and arranged to include at least one of text or an image, and a light that illuminates the portion in response to the sensor sensing the user interaction with the office product. Moreover, the device can include a recess and one of a transparent and translucent cover arranged to cover the recess. The cover can be structured and arranged to hold the at least one text and image. Additionally, the office product can be a stapler and the portion is located in a handle of the stapler. Furthermore, the sensor can include a switch that is actuated by movement of the handle, and a circuit that detects actuation of the switch and that outputs power to the light. Also, the light can include a light emitting diode and the portion can include two fluids having a first and second density with an article floating in the two fluids, where the article holds the at least one text or an image. The device may also include a light emitting diode and a fiber optic element. Moreover, the fiber optic element can include slots or holes that emit light from the light emitting diode. The light may also include a light emitting diode and the portion may include two fluids having a first and second density with an article floating in the two fluids, where the article holds the at least one text or image. Furthermore, the circuit can include an integrated circuit. Moreover, the device can be used in a stapler having a stapler handle, a staple cartridge, and a stapler base. Additionally, the sensor can sense user interaction by movement of the staple cartridge.

Another aspect of the present invention includes a method of illuminating an office product including sensing user interaction with the office product, arranging a portion on the office product to include at least one of text or image, and illuminating the portion in response to sensing user interaction with the office product. Furthermore, the office product can be a stapler and the portion can be located in a handle of the stapler. Moreover, the portion can include two fluids having a first and second density with an article floating in the two fluids, where the article holds the at least one text or an image. Additionally, the illuminating can include repeatedly illuminating a light for a limited time. The method can further include covering a recess of the portion with one of a transparent and translucent cover, where the cover is structured and arranged to hold the at least one text and image. Moreover, the user interaction can be movement a component of the stapler.

Yet another aspect of the present invention includes a stapler, having a stapler handle, a staple cartridge, and a stapler base. The stapler further includes a switch that is actuatable by user interaction with the stapler, a light located in the stapler handle that illuminates a portion of the stapler, a circuit that outputs power to the light in response to actuation of the switch, one of a transparent and translucent cover that covers the light, and a recess that holds the light beneath the cover. The cover being structured and arranged to hold the at least one of text and an image. The circuit can include an integrated circuit. Moreover, the device can include a sensor that senses user interaction with the office product and a LCD display on the office product that displays at least one of text or an image in response to the sensor sensing interaction with the office product. Furthermore, the office product can be a stapler and the display can be located in a handle of the stapler. Additionally, the sensor can include a switch that is actuated by movement of the office product and a circuit that detects actuation of the switch and that actuates the display. Moreover, the circuit can include an integrated circuit.

Another aspect of the invention includes a stapler, having a stapler handle, a staple cartridge, and a stapler base. The stapler includes a switch that is actuatable by movement of the stapler cartridge, a light located in the stapler handle that illuminates a portion of the stapler, a circuit that outputs power to the light in response to actuation of the switch, one of a transparent and translucent cover that covers the light, and a recess that holds the light beneath the cover. Where the cover is structured and arranged to hold the at least one of text and an image.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a top view of an exemplary embodiment of the invention implemented in a stapler device;

FIG. 2 is a side view of an exemplary embodiment of the invention implemented in a stapler device;

FIG. 3 is a circuit diagram according to an exemplary embodiment of the invention;

FIG. 4 is a top view of another embodiment of the invention implemented in a stapler device; and

FIG. 5 is a side view of a portion of another embodiment of the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

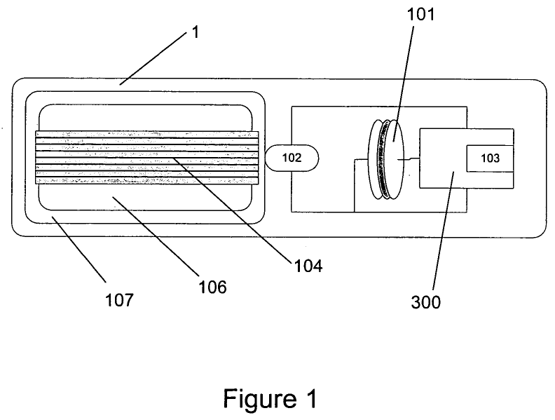

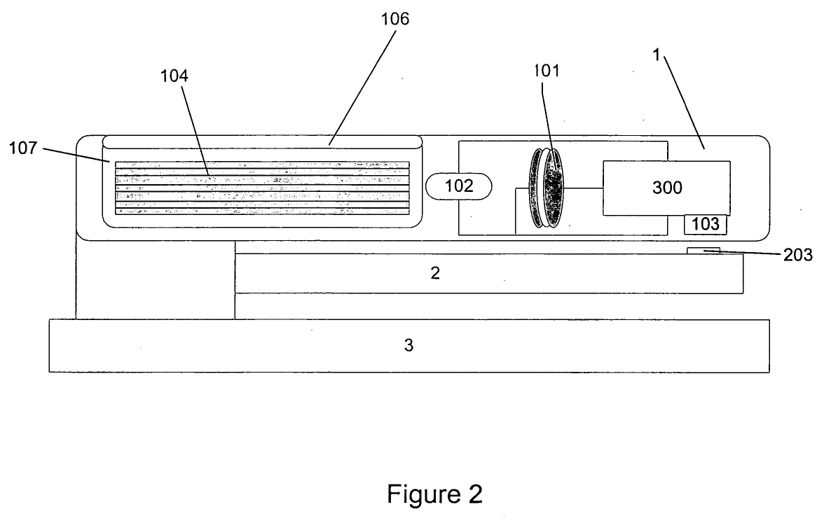

FIGS. 1 and 2 show an exemplary embodiment of the present invention implemented in a stapler. When a user interacts with the stapler, e.g. stapling sheets of paper together, at least a portion of the stapler will illuminate. The stapler includes a stapler handle 1, a staple cartridge 2, and a stapler base 3. Actuation of the stapler handle 1 by the user will cause the stapler handle 1, staple cartridge 2, and stapler base 3 to rotate around a pivot (not shown) in order to extend a staple from the staple cartridge 2 to staple sheets of paper together. The stapler of the present invention further includes a light 102 and a sensor 103 that detects interaction by a user and actuates the light 102 in response.

In the present invention the light 102 can be, for example only, a light emitting diode (LED), a neon light, an incandescent light bulb, or any other suitable light-emitting device. Furthermore, the light 102 can include plural lights and additionally the light 102 can be one or more colors.

The light 102 can be positioned on or in any portion of the stapler. The stapler is structured so that the light from the light 102 can be seen by the user. For example, the light 102 can be mounted to the surface of the stapler. Alternatively, the light 102 is mounted inside the stapler and the stapler includes structure enabling the user to see the light 102. Such structure can be a hole in which the light 102 is mounted. Alternatively, the light 102 can be mounted behind a transparent or translucent portion of the stapler structure. In yet another alternative, a large portion or the entire stapler can be transparent or translucent such that the light from the light 102 can be seen by the user.

In one aspect of the present invention, shown in FIG. 2, the light 102 is mounted within the stapler handle 1. The light 102 is an LED positioned in the stapler handle 1 to illuminate a portion of the stapler handle 1.

The illuminated portion can be used to illuminate a mounted promotional or novelty message, image, and/or text. In one aspect of the invention, the light 102 can be mounted in a recess 107 of the stapler beneath a cover 106. The cover 106 can be formed at least in part by a transparent or translucent material such as glass or plastic. The cover 106 can be engraved with one or more of the message, image, and/or text. Alternatively, the cover can be used to mount or hold one or more of the message, image, or text. The one or more of the message, image, or text can be a promotional message (e.g. a company name), can be personalized, or can be a novelty message (e.g. World's Best Dad). Furthermore, in order to spread the light more evenly throughout the cover 106, the light 102 can be positioned proximate to an optical device the will operate to spread the light.

The optical device can be, for example, a fiber optic tube 104. The fiber optic tube 104 can have a cross-section that is round, square, or some other polygonal shape. Furthermore, the fiber optic tube 104 can include a plurality of holes or slots that allow the light therein to be emitted. In operation, the light 102 will be positioned adjacent to the fiber optic tube 104 to illuminate the fiber optic tube 104. The fiber optic tube 104 will then in turn illuminate the portion of the stapler handle 1 where the cover 106 is mounted.

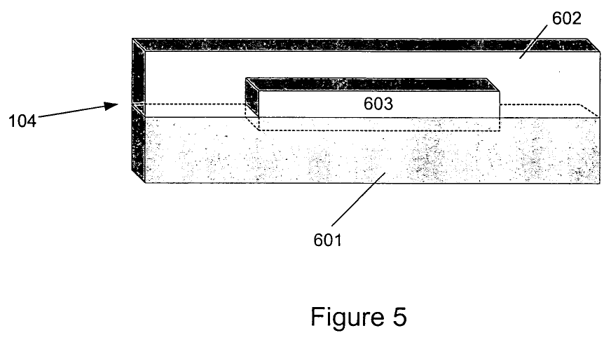

As alternatively shown in FIG. 5, the optical device can be a tube 104 holding one or more liquids. In one aspect of the invention, there are two liquids that have two distinct densities and the liquids have different colors. The distinct colors and densities of the liquids create an entertaining and novel effect. The liquid with the greater density 601 will tend to settle in the lower portion of the tube 104 whereas the liquid with a lower density 602 will float to an upper portion of the tube 104. When the tube 104 moves the two liquids will form waves with respect to one another. Additionally, the tube 104 can contain an article 603 that can be used to mount or hold one or more of the message, image, or text. This article 603 will have a density such that it floats between the greater and lower density fluids. Furthermore, the article can take any known shape to increase appeal and interest. In this aspect of the invention, the light 102 is positioned proximate to the tube 104 holding the liquids and this will operate to spread the light through the liquids.

Next, the operation of the sensor 103 will be discussed. The sensor 103 that senses interaction by the user with the office product can be a switch that detects movement of the office product components. For example, a switch that is biased open or closed such that movement of the stapler handle 1, staple cartridge 2, and/or stapler base 3 of the stapler will close or open the switch respectively. Alternatively, the sensor 103 can be a sensor that detects movement of the entire office product. For example, the sensor 103 can include a mercury switch that senses movement of the office product by movement of a ball of mercury that contacts two or more electrical contacts to complete a switch circuit. It should be apparent that it is within the spirit and scope of the present invention to use any type of sensor that can sense when there is interaction by a user with the office product.

In one aspect of the invention shown in FIG. 2, switch 103 can be mounted inside the stapler handle 1 adjacent to the staple cartridge 2. During the stapling operation, the stapler handle 1 and staple cartridge 2 will rotate with respect to one another about their common pivot. During the rotation, a portion of the staple cartridge will contact and close/open the switch 103. Staple cartridge 2 can also include additional structure such as an extension 203 that will contact switch 103. However, it should be noted that extension 203 is only needed in staplers where the staple cartridge 2 does not sufficiently rotate to contact switch 103. Alternatively or additionally, switch 103 can include an extension connected to switch 103 to enable the staple cartridge 2 to actuate switch 103.

Next, the associated circuitry of the sensor 103 will be discussed. The sensor 103 will include mechanical and electrical components that enable the light 102 to illuminate in response to the sensor 103 sensing interaction with the user. It should be apparent that it is within the spirit and scope of the present invention to use any electrical circuit that can detect actuation of a switch or sensor 103 and in response thereto output a signal to operate the light 102 such as an analog circuit, smart card, digital circuit, integrated circuit, or microprocessor. The electrical circuit in response to receiving the sensor 103 input, will drive or provide electrical power to the light 102. Additionally, the electrical circuit can drive or power the light 102 in such a manner that can be entertaining to the user and will drive or power the light 102 for a limited time in order to conserve power. For example, the light 102 can flash in an entertaining manner, flash different colors, or multiple lights can flash at different times and colors.

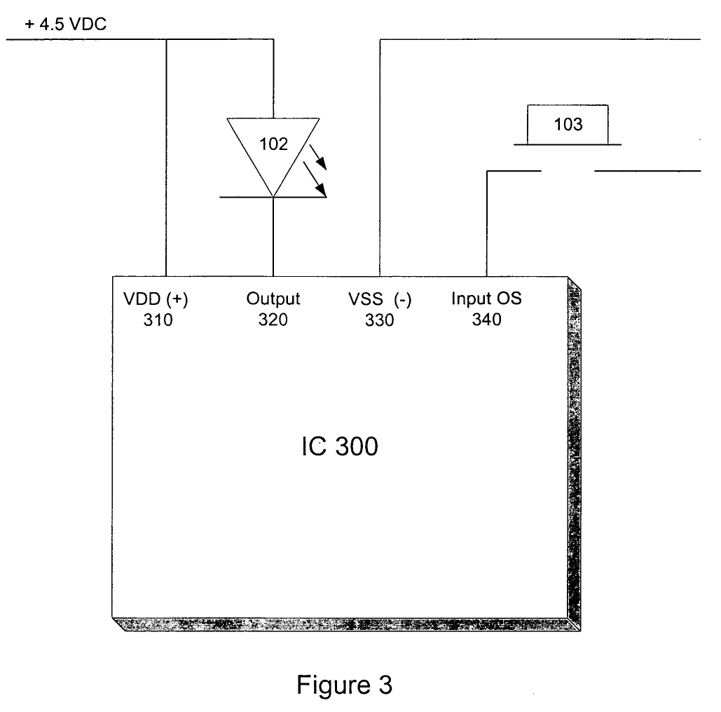

According to an exemplary embodiment of the present invention, an integrated circuit (IC) 300, e.g. Model No. PCB-STP-01 from Golden Right Ltd. of Taiwan, is illustrated in FIG. 3. The IC 300 includes a voltage drain drain (VDD) 310 that is connected through line 340 to one or more batteries 101. VDD 310 is the positive power connection for providing power to the IC 300. The IC 300 also includes an output 320 for completing the circuit with the light 102. For example as shown in FIG. 3, the output 320 completes the circuit with the light 102, e.g. an LED. The IC 300 also includes a voltage for substrate and sources (VSS) 330 for providing power to the IC 300 by connection to a negative terminal of the one or more batteries 101. The IC 300 includes an input 340 that is a voltage offset (OS). The input 340 is connected to the switch 103 and in turn, the switch 103 is connected to either a positive or negative terminal of the one or more batteries 101. For example, the batteries providing 4.5 volts of direct current as shown in FIG. 3.

Next, the operation of the IC 300 will be discussed. When an appropriate power supply is connected to the VDD 310 and the VSS 330, the IC 300 will be operationally powered. When the switch 103 is either closed or opened for a predetermined time, the input 340 will be recognized as an offset in the voltage. The IC 300 will then send power through the output 320 to light the light 102. In an aspect of the present invention the IC 300 will power the light 102 after receiving input from the sensor 103 at the input 340. In a particular embodiment, the IC 300 will repeatedly provide power to the light 102 in order to make the light 102 blink. For example, the power can be applied to the light 102 for ½ second and removed for ½ second for seven seconds. However, it should be apparent that any number of blinks, having any blink length and/or variable blink length would be within the spirit and scope of the present invention.

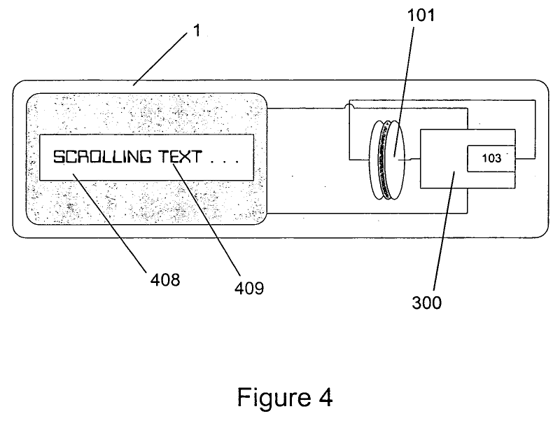

FIG. 4 shows another embodiment of the present invention that includes a liquid crystal display (LCD) 408. The LCD 408 can be used instead of the light 102 and optic tube 104. Alternatively, the LCD 408 can include the light 102 and optic tube 104 mounted below LCD 408 in order to illuminate the LCD 408. The LCD 408 includes two pieces of polarized glass. The LCD 408 further includes a polymer that forms microscopic grooves in a surface along with a coating of nematic liquid crystals. In this aspect of the invention, the IC 300 will include additional conventional features that are within spirit and scope of the present invention such as additional input, timing, and controller features. In particular, IC 300 will include a plurality of outputs 320 and each output of the IC 300 applies an electric charge to a portion of the LCD 408 to align the liquid crystals to form part of each character. Repeating and changing this application of electricity by IC 300 then creates, for example, a scrolling text message 409 across the LCD 408. The IC 300 can be programmed to provide a scrolling message that is one or more of the message, image, or text that can be a promotional message, can be personalized, or can be a novelty message.

The present invention, as described above, includes an office product with a sensor 103 that can determine when a user is interacting with the office product. In response to the interaction with the office product, the office product will illuminate at least a portion of the office product with a light 102 in an entertaining manner. Finally, the portion of the office product that is illuminated can include a transparent or translucent cover and can also include a promotional or personalized message, image, or text in order for the stapler to be more useful as a promotional device, novelty item, and/or as a gift.

Although the present description has been directed to a office product that includes the sensor 103 and light 102, it should be apparent that the present invention would work equally well in modifying an office product to operate according to the present invention and further would work on any type of office equipment (e.g. hole punch, penholder, business card holder, mouse pad, etc.).

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A device that illuminates an office product comprising:
a sensor that senses user interaction with the office product;
a portion of the office product that is structured and arranged to include at least one of text or an image; and
a light that illuminates the portion in response to the sensor sensing the user interaction with the office product.

2. The device according to claim 1 wherein the portion comprises:
a recess; and
one of a transparent and translucent cover arranged to cover the recess,
wherein the cover is structured and arranged to hold the at least one text and image.

3. The device according to claim 2 wherein the office product is a stapler and the portion is located in a handle of the stapler.

4. The device according to claim 3 wherein the sensor further comprises:
a switch that is actuated by movement of the handle; and
a circuit that detects actuation of the switch and that outputs power to the light.

5. The device according to claim 4 wherein the circuit outputs power to the light to repeatedly flash the light for a limited time.

6. The device according to claim 1 wherein the sensor further comprises:
a switch that is actuated by movement of the office product; and
a circuit that detects actuation of the switch and that outputs power to the light.

7. The device according to claim 6 wherein the circuit outputs power to the light to repeatedly flash the light for a limited time.

8. The device according to claim 6 wherein the light comprises a light emitting diode and the portion includes two fluids having a first and second density with an article floating in the two fluids,
wherein the article holds the at least one text or an image.

9. The device according to claim 1 wherein the light comprises a light emitting diode and a fiber optic element.

10. The device according to claim 9 wherein the fiber optic element includes slots or holes that emit light from the light emitting diode.

11. The device according to claim 1 wherein the light comprises a light emitting diode and the portion includes two fluids having a first and second density with an article floating in the two fluids,
wherein the article holds the at least one text or an image.

12. The device according to claim 7 wherein the circuit comprises an integrated circuit.

13. A stapler using the device according to claim 1 further comprising:
a stapler handle;
a staple cartridge; and
a stapler base.

14. The stapler according to claim 13, wherein the sensor senses user interaction by movement of the staple cartridge.

15. A method of illuminating an office product comprising:
sensing user interaction with the office product;
arranging a portion of the office product to include at least one of text or image; and
illuminating the portion in response to sensing user interaction with the office product.

16. The method according to claim 15 wherein the office product is a stapler and the portion is located in a handle of the stapler.

17. The method according to claim 15 wherein the portion includes two fluids having a first and second density with an article floating in the two fluids,
wherein the article holds the at least one text or an image.

18. The method according to claim 15 wherein the illuminating includes repeatedly illuminating a light for a limited time.

19. The method according to claim 15 further comprises:
covering a recess of the portion with one of a transparent and translucent cover,
wherein the cover is structured and arranged to hold the at least one text and image.

20. The method according to claim 15 wherein the user interaction is movement of a component of the stapler.

21. A stapler, having a stapler handle, a staple cartridge, and a stapler base comprising:
a switch that is actuatable by user interaction with the stapler;
a light located in the stapler handle that illuminates a portion of the stapler;
a circuit that outputs power to the light in response to actuation of the switch;
one of a transparent and translucent cover that covers the light; and
a recess that holds the light beneath the cover,
wherein the cover is structured and arranged to hold the at least one of text and an image.

22. The device according to claim 21 wherein the circuit comprises an integrated circuit.

23. A device that displays at least one of text or an image on an office product comprising:
a sensor that senses user interaction with the office product; and
a LCD display on the office product that displays at least one of text or an image in response to the sensor sensing interaction with the office product.

24. The device according to claim 23 wherein the office product is a stapler and the display is located in a handle of the stapler.

25. The device according to claim 23 wherein the sensor further comprises:
a switch that is actuated by movement of the office product; and
a circuit that detects actuation of the switch and that actuates the display.

26. The device according to claim 25 wherein the circuit comprises an integrated circuit.

27. A stapler, having a stapler handle, a staple cartridge, and a stapler base comprising:
a switch that is actuatable by movement of the stapler cartridge;
a light located in the stapler handle that illuminates a portion of the stapler;
a circuit that outputs power to the light in response to actuation of the switch;
one of a transparent and translucent cover that covers the light; and
a recess that holds the light beneath the cover,
wherein the cover is structured and arranged to hold the at least one of text and an image.
